(19) United States
(12) Patent Application Publication
(10) Pub. No.: US 2022/0067183 A1
(43) Pub. Date: Mar. 3, 2022

(54) INFORMATION PROCESSING APPARATUS AND NON-TRANSITORY COMPUTER READABLE MEDIUM

(71) Applicant: FUJIFILM BUSINESS INNOVATION CROP., Tokyo (JP)

(72) Inventor: Satoshi KINOSHITA, Kanagawa (JP)

(73) Assignee: FUJIFILM BUSINESS INNOVATION CORP., Tokyo (JP)

(21) Appl. No.: 17/176,724

(22) Filed: Feb. 16, 2021

(30) Foreign Application Priority Data
Sep. 2, 2020 (JP) 2020-147345

(51) Int. Cl. G06F 21/62

(52) U.S. Cl. CPC G06F 21/6218

(57) ABSTRACT

An information processing apparatus includes: a memory that stores objects and administrators managing the objects in association with each other; and a processor configured to select, among the administrators stored in the memory, a second administrator to replace a first administrator managing a first object, as an administrator of the first object, the second administrator being different from the first administrator, and to determine that the first object will be deleted if the processor has failed to select the second administrator.

### CROSS-REFERENCE TO RELATED APPLICATIONS

This application is based on and claims priority under 35 USC 119 from Japanese Patent Application No. 2020-147345 filed Sep. 2, 2020.

### BACKGROUND

### (i) Technical Field

The present disclosure relates to an information processing apparatus and a non-transitory computer readable medium.

### (ii) Related Art

Japanese Unexamined Patent Application Publication No. 2015-133010 discloses the following technology which is able to transfer a management right from one user to another user. More specifically, when a management right user having a management right for an object, such as a folder, is deleted, the management right for this object is transferred to another management right user suitable for the object. A document processing device includes the following elements. A user deletion detector detects that a user has been deleted. A folder detector detects a folder for which a management right user is eliminated due to the deletion of this user. By referring to an attribute table stored in an attribute table storage and a job title table stored in a job title table storage, a management right user selector selects a new management right user for the folder from among users having write authorization, delete authorization, and read authorization for this folder. A management right user setter sets the selected new management right user in the folder.

Japanese Unexamined Patent Application Publication No. 2007-172280 discloses the following technology which is be able to assist in suitably reallocating an access right allocated to a group which has been eliminated due to reorganization to another group. An account comparator compares account information of groups before reorganization and that after reorganization so as to determine a group deleted due to reorganization. An updating information creator extracts, among the remaining or new groups after reorganization, a group whose members match those of the deleted group at a predetermined ratio or greater, and sets the extracted group as a candidate which may replace the deleted group. An updating request notifier notifies an object owner user who has granted the access right to the deleted group that it is necessary to change the group to which the access right is granted. An updating information presenter presents candidates which may be able to replace the deleted group and instructs the user to select one of the candidates. An access right replacer rewrites an access control list (ACL) stored in an ACL manager in accordance with the selection result.

Japanese Unexamined Patent Application Publication No. 2010-160618 discloses a document management device that can allow only a specific user to access a folder or a file even after the user account of this user is deleted. More specifically, folders and files managed in the document management device include highly confidential documents and private information that can be accessed only by a specific user. After the user account of a user having an access right to a specific folder or file is deleted due to a job transfer, for example, the document management device still allows only this user to access this folder or file. More specifically, when the user account of a user is deleted, a file that this user is authorized to access is encrypted and stored in a shared area. A guest account for accessing the shared area and a password for decrypting the encrypted file are given to this user. The user is then able to log in the document management device with the guest account so as to access the file.

### SUMMARY

When the administrator who manages an object is changed to a new one, it is less likely that the new administrator understands the content of the object as the previous administrator. The new administrator is thus unable to judge whether to delete the object, which may lead to a waste of the storage space for the object.

Aspects of non-limiting embodiments of the present disclosure relate to an information processing apparatus and a non-transitory computer readable medium in which, when replacing an administrator managing an object, if a new administrator is not found, the object which may waste the storage space can be deleted, unlike when an object administrator is simply replaced by a new one.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a memory that stores objects and administrators managing the objects in association with each other; and a processor configured to select, among the administrators stored in the memory, a second administrator to replace a first administrator managing a first object, as an administrator of the first object, the second administrator being different from the first administrator, and to determine that the first object will be deleted if the processor has failed to select the second administrator.

### BRIEF DESCRIPTION OF THE DRAWINGS

An exemplary embodiment of the present disclosure will be described in detail based on the following figures, wherein:

FIG. 1 is a block diagram illustrating conceptual modules forming an example of the configuration of the exemplary embodiment;

FIG. 2 is a block diagram illustrating an example of the system configuration utilizing the exemplary embodiment;

FIG. 3 is a block diagram illustrating specific modules forming an example of the configuration of the exemplary embodiment;

FIG. 4 is a flowchart illustrating an example of processing executed in the exemplary embodiment;

FIG. 5 illustrates an example of the data structure of a user management table;

FIG. 6 illustrates an example of the data structure of an object management table;

FIG. 7 illustrates an example of the data structure of an object-and-access-right management table;

FIG. 8 illustrates an example of the data structure of a subject object management table;

FIG. 9 is a flowchart illustrating an example of processing executed in the exemplary embodiment;

FIG. 10 illustrates an example of the data structure of a log management table;

FIG. 11 illustrates an example of the data structure of a candidate management table;

FIG. 12 illustrates an example of the data structure of a delete condition management table;

FIG. 13 is a flowchart illustrating an example of processing executed in the exemplary embodiment;

FIG. 14 is a flowchart illustrating an example of processing executed in the exemplary embodiment;

FIG. 15 is a flowchart illustrating an example of processing executed in the exemplary embodiment;

FIG. 16 is a flowchart illustrating an example of processing executed in the exemplary embodiment; and

FIG. 17 is a flowchart illustrating an example of processing executed in the exemplary embodiment.

### DETAILED DESCRIPTION

An exemplary embodiment of the disclosure will be described below with reference to the accompanying drawings.

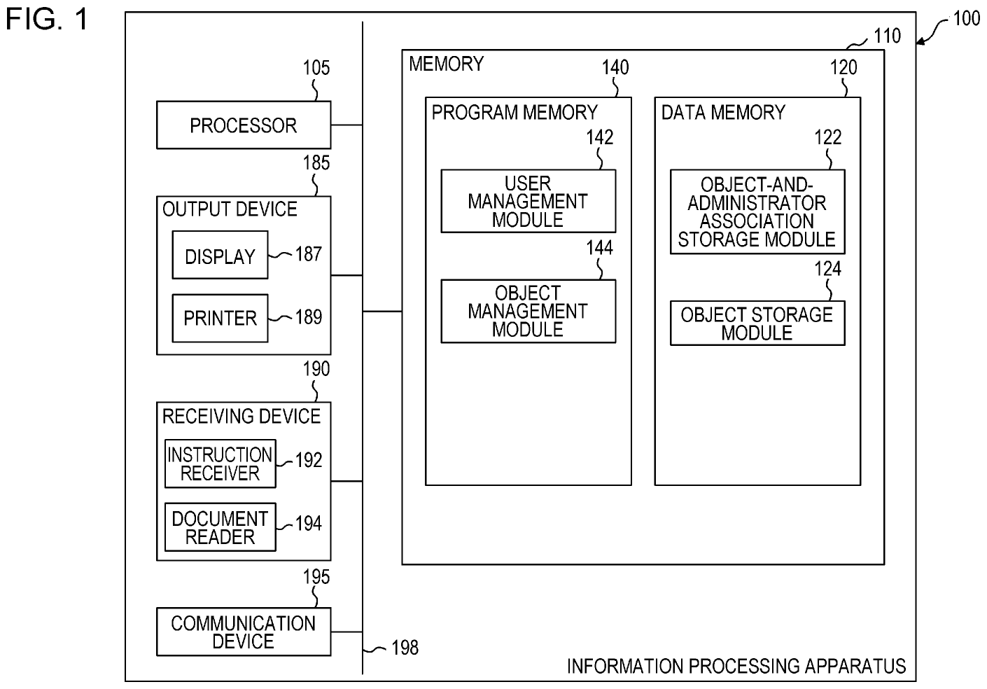

FIG. 1 is a block diagram illustrating conceptual modules forming an example of the configuration of the exemplary embodiment.

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus (or a device) may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include a mere man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted.

An information processing apparatus 100 has a function of executing processing for setting an object administrator. As shown in the example in FIG. 1, the information processing apparatus 100 at least includes a processor 105 and a memory 110. A bus 198 connects the processor 105 and the memory 110 so that they can exchange data therebetween. The information processing apparatus 100 may also include an output device 185, a receiving device 190, and a communication device 195. Data is exchanged between the processor 105, the memory 110, the output device 185, the receiving device 190, and the communication device 195 via the bus 198.

The block diagram of FIG. 1 also illustrates an example of the hardware configuration of a computer implementing the exemplary embodiment. The computer on which a program serving as the exemplary embodiment is executed has a hardware configuration, such as that shown in FIG. 1, and more specifically, a computer which serves as a personal computer (PC) or a server. A specific example of such a computer utilizes the processor 105 as a processing unit and the memory 110 as a storage device.

As the processor 105, one or multiple processors may be used. The processor 105 may include a central processing unit (CPU) or a microprocessor, for example. If multiple processors 105 are used, they may be implemented as either one of a tightly coupled multiprocessor and a loosely coupled multiprocessor. For example, multiple processor cores may be loaded within a single processor 105. A system in which plural computers connect with each other via a communication channel so as to behave like one computer in a virtual manner may be utilized. As a specific example, multiple processors 105 may be a loosely coupled multiprocessor and be formed as a cluster system or a computer cluster. The processor 105 executes programs stored in a program memory 140.

The memory 110 may include semiconductor memory units within the processor 105, such as a register and a cache memory. The memory 110 may include a main memory device (main storage device) constituted by a random access memory (RAM) and a read only memory (ROM), for example, an internal storage device having a function as a persistent storage, such as a hard disk drive (HDD) and a solid state drive (SDD), and an external storage device and an auxiliary storage device, such as a compact disc (CD), a digital versatile disk (DVD), a Blu-ray (registered trademark) disc, a universal serial bus (USB) memory, and a memory card. The memory 110 may also include a storage, such as a server, connected to the information processing apparatus 100 via a communication network.

The memory 110 includes as major elements a data memory 120 principally storing data and a program memory 140 principally storing programs. In the program memory 140, in addition to the module programs shown in FIG. 1, programs, such as an operating system (OS) for starting the computer, may be stored. In the data memory 120, in addition to the storage modules shown in FIG. 1, data, such as parameters that appropriately change during the execution of the module programs, may be stored.

The output device 185 includes a display 187 and a printer 189, for example. The display 187 is a liquid crystal display, an organic electroluminescence (EL) display, a three-dimensional (3D) display, or a projector, for example. The display 187 displays processing results of the processor 105 and data stored in the data memory 120 as text or image information, for example. The printer 189, which is a printing device or a multifunction device, prints processing results of the processor 105 and data stored in the data memory 120, for example. The output device 185 may include a speaker and an actuator for vibrating equipment.

The receiving device 190 includes an instruction receiver 192 and a document reader 194, for example. The instruction receiver 192 is a keyboard, a mouse, a microphone, or a camera (including a gaze detection camera) and receives data based on an operation (including motion, voice, and gaze) performed on the instruction receiver 192 by a user.

A device having both the functions of the display 187 and the instruction receiver 192, such as a touchscreen, may be used. In this case, to implement the function of the keyboard, a keyboard drawn on the touchscreen by using software, that is, a software keyboard or a screen keyboard, may be used instead of a physical keyboard.

As a user interface (UI), the display 187 and the instruction receiver 192 are principally used.

The document reader 194, which is a scanner or a camera, for example, reads or captures an image of a document and receives image data generated from the read or image-captured document.

The communication device 195 is a communication network interface, such as a network card, for enabling the information processing apparatus 100 to connect to another apparatus via a communication network.

In the above-described exemplary embodiment, concerning elements implemented by a software computer program, such a computer program is read into the program memory 140, and the exemplary embodiment is implemented by a combination of software and hardware resources. That is, the exemplary embodiment is specifically implemented as a result of executing software information processing by using hardware resources (using at least the processor 105 and the memory 110 and using the output device 185, the receiving device 190, and the communication device 195 if necessary), based on a law of nature as a whole.

The hardware configuration shown in FIG. 1 is only an example, and the exemplary embodiment may be configured in any manner if the modules described in the exemplary embodiment are executable. For example, as the processor 105, a graphics processing unit (GPU) or a general-purpose computing on graphics processing unit (GPGPU) may be used. Some modules may be configured as dedicated hardware, for example, an application specific integrated circuit (ASIC) or a field-programmable gate array (FPGA), or some modules may be installed in an external system and be connected to the information processing apparatus 100 via a communication network. A system, such as that shown in FIG. 1, may be connected to a system, such as that shown in FIG. 1, via a communication network, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, and a multifunction device (an image processing apparatus including at least two of the functions of a scanner, a printer, a copying machine, and a fax machine).

The processor 105 is connected to the memory 110, the output device 185, the receiving device 190, and the communication device 195 via the bus 198. The processor 105 executes processing in accordance with a computer program describing an execution sequence of each module, which is a program stored in the program memory 140. For example, in response to the instruction receiver 192 receiving a user operation, the processor 105 executes processing by using the module stored in the program memory 140 corresponding to the received operation, and stores the processing result in the data memory 120, outputs it to the display 187, or controls the communication device 195 to send the processing result to another apparatus.

The memory 110 includes the data memory 120 and the program memory 140 and is connected to the processor 105, the output device 185, the receiving device 190, and the communication device 195 via the bus 198.

The data memory 120 includes an object-and-administrator association storage module 122 and an object storage module 124.

The object-and-administrator association storage module 122 stores objects and administrators managing the objects in association with each other. An object is a file, such as a document, or a folder, for example.

The object storage module 124 stores objects. The object storage module 124 may store objects themselves or information indicating locations where the objects are stored, such as uniform resource locators (URLs). The object storage module 124 may also store attributes of objects.

The program memory 140 includes a user management module 142 and an object management module 144.

The user management module 142 conducts management of users. “Conducting management of users” refers to determining whether a subject user is the administrator of an object and also judging whether a subject user is suitable as the administrator of an object. For example, when a subject user is being transferred or has been transferred to another department or is retiring or has retired, it is determined that this subject user is not suitable as the administrator of an object.

When changing the administrator of a certain object, the object management module 144 selects the next administrator to replace the current or previous administrator, and if it has failed to select the next administrator, it determines that this object will be deleted. That is, among administrators, the object management module 144 selects a second administrator to replace a first administrator managing an object as the administrator of this object. The second administrator is different from the first administrator. If the object management module 144 has failed to select the second administrator, it determines that the object managed by the first administrator will be deleted. The administrator managing an object is the current or previous administrator, and is an example of the first administrator. The next administrator is a user to replace the first administrator and will manage the object after the first administrator. For example, if the first administrator is retiring and becomes unsuitable as the administrator, another user replaces the first administrator and such a user is an example of the second administrator. The second administrator may be any user who is different from the first administrator. The second administrator may be a user who is already the administrator of another object or who is not the administrator of any object.

After it is determined that a certain object will be deleted, a query may be made to a user using the information processing apparatus 100 as to whether to delete the object, or the object may be deleted without making such a query.

As discussed above, an object may be a file or a folder. After file deletion processing is executed, folder deletion processing is executed. More specifically, the next administrator is first selected for a file, and then, the next administrator is selected for a folder in a manner similar to the file. When all the files in this folder have been deleted, the folder is deleted.

The object management module 144 may delete an object by switching the rule according to whether or not the user using the information processing apparatus 100 is the administrator of this object.

The administrator is the administrator of an object to be deleted.

If the user using the information processing apparatus 100 is the administrator of the object to be deleted, the object management module 144 may utilize a rule set by this user. As the rule set by the user, a rule based on an attribute of an object, which will be discussed later, may be utilized. Even in this case, the user, who is the administrator, selects a rule to be used or a threshold to be used for a rule.

If the user using the information processing apparatus 100 is not the administrator of the object to be deleted, the object management module 144 may utilize a rule based on an attribute of the object.

Examples of the rule based on an attribute of the object are that the size of the object is greater than or equal to a predetermined size, the fee for storing the object is higher than or equal to a predetermined fee, the type of object (for example, an extension of the object if the object is a file) is a predetermined type, the last modification date and time is a predetermined date and time or earlier, the file name of the object includes a predetermined character string, and the registration date and time of the object is a predetermined date and time or earlier.

When selecting the next administrator as the administrator of an object, the object management module 144 may select a user who is authorized to write into the object and has written into the object as the next administrator (processing A).

If the object management module 144 has failed to select the next administrator by executing processing A, it may select a user who is authorized to delete the object and has deleted a different version of the object as the next administrator (processing B).

If the object management module 144 has failed to select the next administrator by executing processing B, it may select a user who is authorized to read the object and has read the object as the next administrator (processing C).

The object management module 144 may cause the user using the information processing apparatus 100 to select whether to prioritize the storing of the object or the reducing of a space required for storing the object. If the user has selected the storing of the object, the object management module 144 may execute processing C.

If the user has selected the reducing of a space required for storing the object, the object management module 144 terminates processing after executing processing A and processing B without executing processing C.

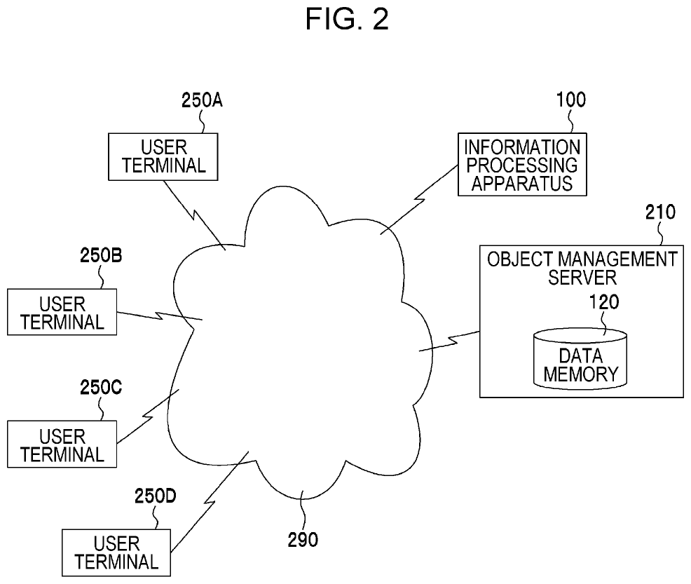

FIG. 2 is a block diagram illustrating an example of the system configuration utilizing the exemplary embodiment.

The information processing apparatus 100, an object management server 210, and user terminals 250A, 250B, 250C, and 250D are connected with one another via a communication network 290. The communication network 290 may be a wireless or wired medium, or a combination thereof, and may be, for example, the Internet or an intranet as a communication infrastructure.

The functions of the information processing apparatus 100 may be implemented as cloud services. The object management server 210 includes a data memory 120. As the data memory 120 shown in FIG. 1, the data memory 120 in the object management server 210 may also be used. The functions of the object management server 210 may also be implemented as cloud services.

The information processing apparatus 100 according to the exemplary embodiment assists with the use of documents in a document management service, in particular, with the management of objects that may become inaccessible in the document management service.

For example, when conducting document management in cloud services such as in the object management server 210, settings of the access right to an object, such as a folder or a file, may be changed.

As the fee system utilized in document management in cloud services, a user usually pays according to the use of objects based on the size or purchases an object by the size unit.

If there are some inaccessible objects, a user wastes money for such inaccessible objects every month. An example of the inaccessible object is as follows. There may be a document that only a specific user can access, and if this specific user has retired or has been transferred to another location, this document becomes inaccessible. That is, a user, who is the administrator of an object, is unable to utilize the object management server 210 due to the deletion of the account of this user, or is able to utilize the object management server 210 but is no longer the administrator of the object.

A function that enables the administrator to access an inaccessible object in a specific mode is available. However, the administrator is unable to judge whether to delete this inaccessible object. The administrator may allocate an access right to another user, but this user is also unable to judge whether to delete this inaccessible object. After all, this object may be left in the cloud services as an inaccessible object.

The information processing apparatus 100 reallocates an object managed by a user to be deleted to another user or deletes this object.

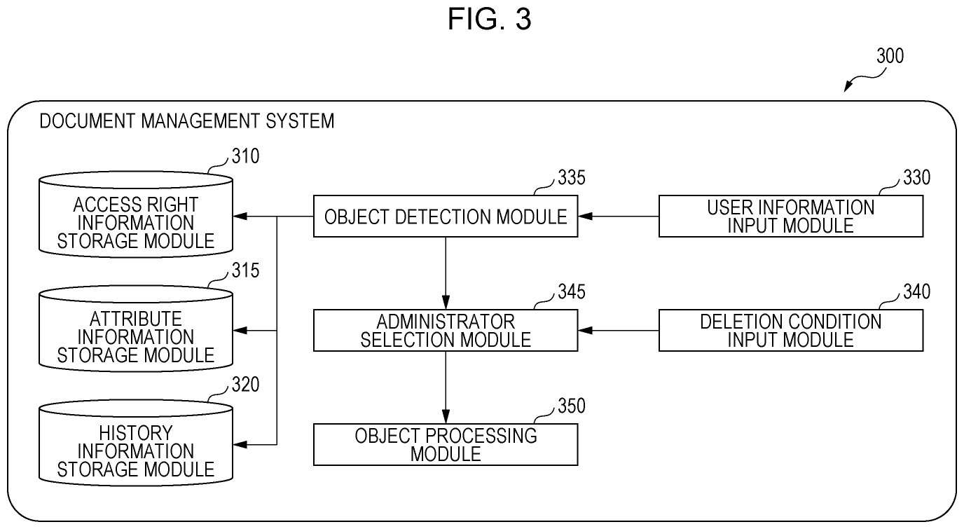

FIG. 3 is a block diagram illustrating specific modules forming an example of the configuration of the exemplary embodiment. A document management system 300 is a specific example of the information processing apparatus 100.

The document management system 300 includes an access right information storage module 310, an attribute information storage module 315, a history information storage module 320, a user information input module 330, an object detection module 335, a deletion condition input module 340, an administrator selection module 345, and an object processing module 350.

The user information input module 330 is connected to the object detection module 335. The user information input module 330 inputs a user to be deleted in accordance with a user operation or predetermined processing. More specifically, the user information input module 330 inputs a user who is retiring or has retired or who is being transferred or has been transferred to another location, for example. A user may input a target user each time or input users in a list including users who are retiring or have retired or users who are being transferred or have been transferred to another location on a regular basis (every month, for example).

The deletion condition input module 340 is connected to the administrator selection module 345. The deletion condition input module 340 sets a condition for deleting an object. As the condition, the condition for deleting an object without checking with the user (operator) of the information processing apparatus 100 may be set. For example, the condition is set based on an attribute of an object, such as the size, the storage fee, the type, the last modification date and time, the file name, and the registration date and time. Specific examples of the condition are those used for the object management module 144 shown in FIG. 1 to delete an object.

The object detection module 335 is connected to the access right information storage module 310, the attribute information storage module 315, the history information storage module 320, the user information input module 330, and the administrator selection module 345. The object detection module 335 extracts objects managed by the users input by the user information input module 330 from the access right information storage module 310. If plural users manage one object, the object detection module 335 extracts this object if all the users managing the object are input by the user information input module 330. In other words, if, for this object, only some users are input by the user information input module 330 but other users are not input, this object is not extracted.

Concerning each of the extracted objects, the object detection module 335 extracts access rights from the access right information storage module 310, attribute information from the attribute information storage module 315, and history information from the history information storage module 320.

The administrator selection module 345 is connected to the object detection module 335, the deletion condition input module 340, and the object processing module 350. The administrator selection module 345 selects the next administrator (new administrator having a management right) of an object extracted by the object detection module 335.

The object processing module 350 is connected to the administrator selection module 345. The object processing module 350 executes deletion processing for an object and changing processing for the access rights of this object.

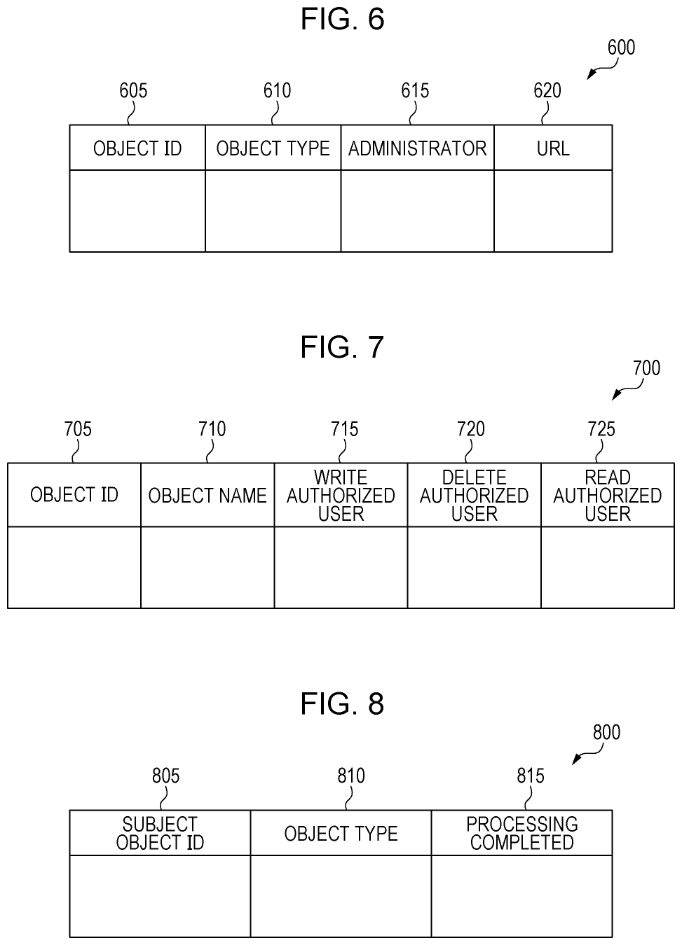

The access right information storage module 310 is connected to the object detection module 335. The access right information storage module 310 stores the access rights of each object. For example, the access right information storage module 310 stores an object management table 600 and an object-and-access-right management table 700, which will be discussed later with reference to FIGS. 6 and 7.

The attribute information storage module 315 is connected to the object detection module 335. The attribute information storage module 315 stores attributes of each object. For example, for each object, the attribute information storage module 315 stores the size, the storage fee, the type, the last modification date and time, the file name, and the registration date and time, for example.

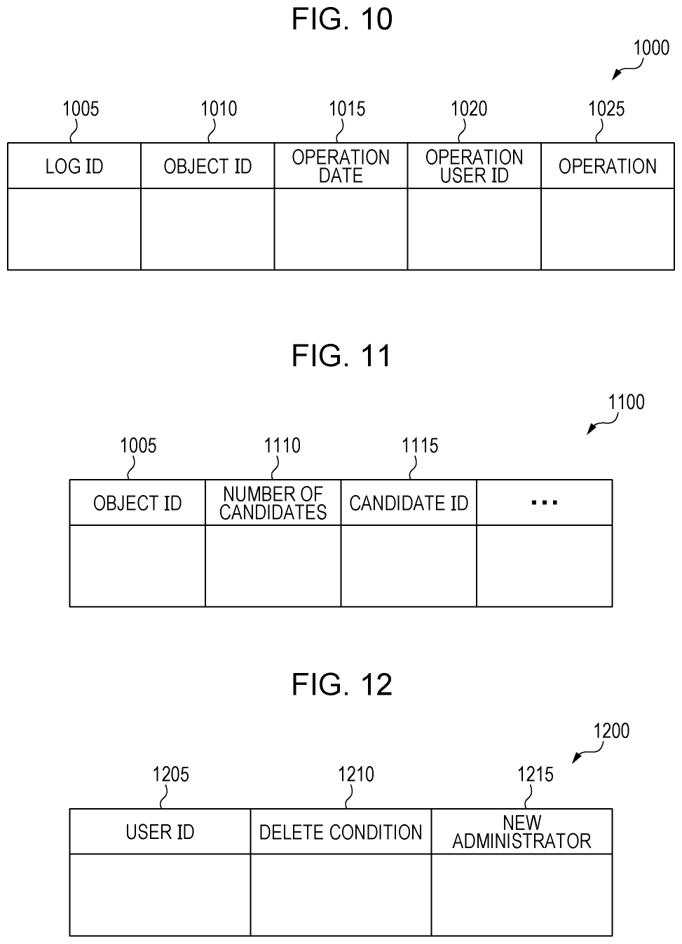

The history information storage module 320 is connected to the object detection module 335. The history information storage module 320 stores the history of operations performed on each object. The history information storage module 320 stores a log management table 1000, which will be discussed later with reference to FIG. 10, for example.

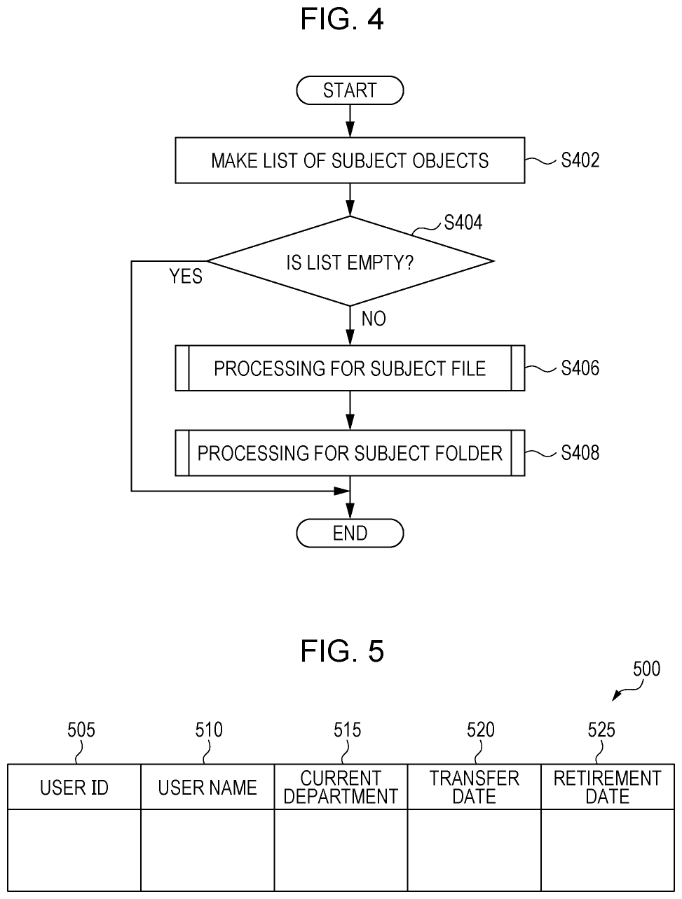

FIG. 4 is a flowchart illustrating an example of processing executed in the exemplary embodiment. As discussed above, a user to be deleted is a user who is retiring or has retired or a user who is being transferred or has been transferred to another location.

In step S402, a list of subject objects is made. More specifically, a list of files and folders managed by administrators who are to be deleted is made.

A judgement as to whether a user is a user to be deleted may be made by using a user management table 500. FIG. 5 illustrates an example of the data structure of the user management table 500. The user management table 500 has a user ID field 505, a user name field 510, a current department field 515, a transfer date field 520, and a retirement date field 525. In the user ID field 505, information for uniquely identifying a user in the exemplary embodiment, more specifically, a user ID, is stored. In the user name field 510, the user name of this user is stored. In the current department field 515, the current department of this user is stored. In the transfer date field 520, the date on which the user is to be transferred or has been transferred is stored. In the retirement date field 525, the date on which the user is to retire or has retired is stored.

A judgement as to whether a user is an administrator may be made by using an object management table 600. FIG. 6 illustrates an example of the data structure of the object management table 600. The object management table 600 has an object ID field 605, an object type field 610, an administrator field 615, and a URL field 620. In the object ID field 605, information for uniquely identifying an object in the exemplary embodiment, and more specifically, an object ID, is stored. In the object type field 610, the object type is stored. For example, as the object type, information indicating that the object is a file or a folder is stored. In the administrator field 615, the administrator of this object is stored. In the URL field 620, the URL indicating the location where this object is stored is indicated.

For example, a user whose transfer date is indicated in the transfer date field 520 or whose retirement date is indicated in the retirement date field 525 in the user management table 500 is extracted. If this user is indicated as the administrator in the administrator field 615 of the object management table 600, the object represented by the object ID in the object ID field 605 is extracted as a subject object.

As a subject object, a file or a folder which is managed by the administrator who is a user to be deleted and which no one else is authorized to access may be selected.

A judgement as to whether no one else is authorized to access may be made by using an object-and-access-right management table 700. FIG. 7 illustrates an example of the data structure of the object-and-access-right management table 700. The object-and-access-right management table 700 has an object ID field 705, an object name field 710, a write authorized user field 715, a delete authorized user field 720, and a read authorized user field 725. In the object ID field 705, an object ID of an object is stored. In the object name field 710, the name of this object, such as the file name or the folder name, is stored. In the write authorized user field 715, a user authorized to write into the object is stored. In the delete authorized user field 720, a user authorized to delete the object is stored. In the read authorized user field 725, a user authorized to read the object is stored. If a user other than the user to be deleted is indicated in any of the write authorized user field 715, the delete authorized user field 720, and the read authorized user field 725, it means that authorization has also been granted to another user. Hence, this object is not selected as a subject object.

For example, a user whose transfer date is indicated in the transfer date field 520 or whose retirement date is indicated in the retirement date field 525 in the user management table 500 is extracted. If this user is indicated as the administrator in the administrator field 615 of the object management table 600, the object represented by the object ID in the object ID field 605 is extracted. Then, if this user is the only user indicated in the write authorized user field 715, the delete authorized user field 720, and the read authorized user field 725 of the object-and-access-right management table 700, the object is selected as a subject object.

Referring back to FIG. 4, it is judged in step S404 whether the list is empty. If the list is empty, processing is terminated. If the list is not empty, the process proceeds to step S406.

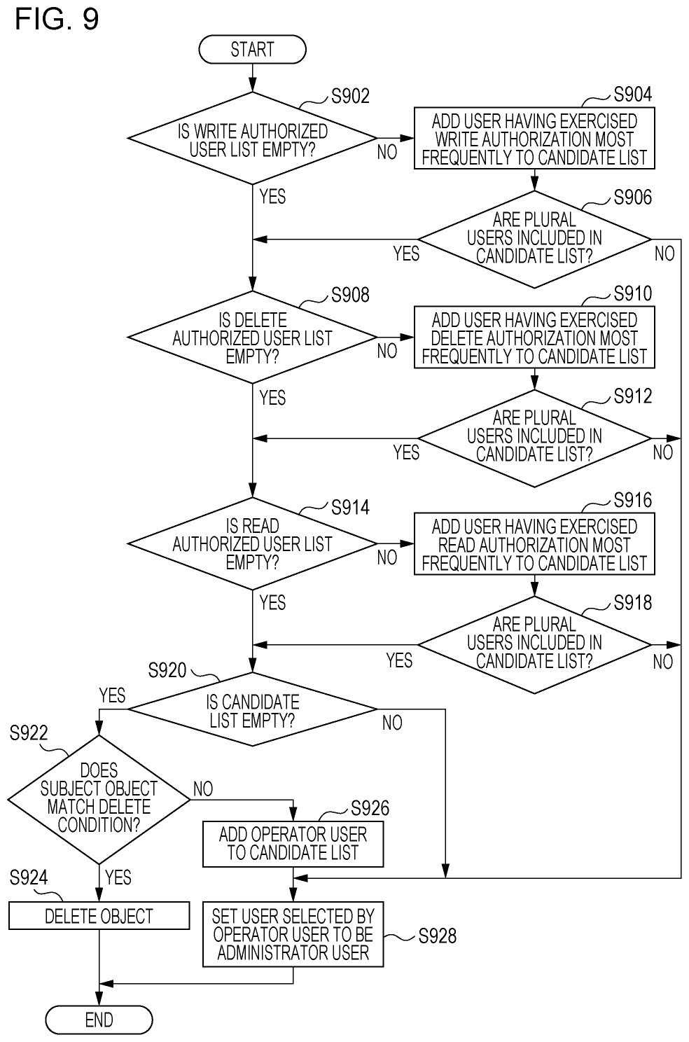

In step S406, processing for a subject file is executed. Details of processing in step S406 will be discussed later with reference to the flowchart of FIG. 9.

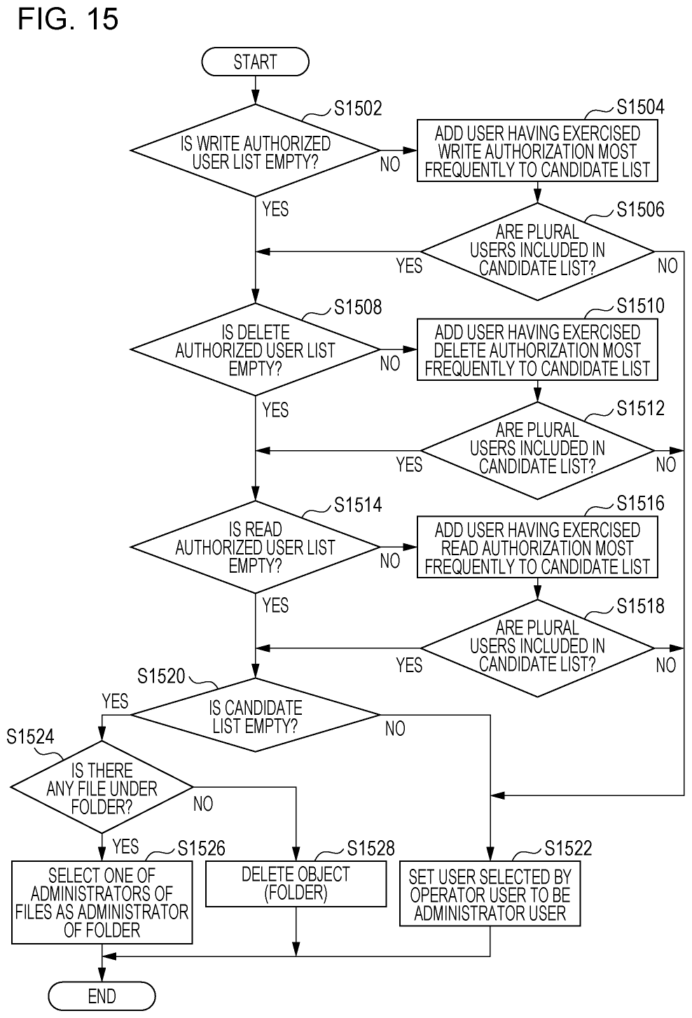

In step S408, processing for a subject folder is executed. Details of processing in step S408 will be discussed later with reference to the flowchart of FIG. 15.

As a result of executing processing in the flowchart of FIG. 4, a subject object management table 800 is generated. FIG. 8 illustrates an example of the data structure of the subject object management table 800. The subject object management table 800 has a subject object ID field 805, an object type field 810, and a processing completion field 815. In the subject object ID field 805, the ID of a subject object is stored. In the object type field 810, the object type of this object is stored. In the processing completion field 815, information indicating whether the object has been processed is stored.

After step S406, processing in step S408 is executed. That is, in folder deletion processing for deleting a folder, when no file is stored in this folder, the folder is deleted. Separately executing step S408 after step S406 can delete, not only a file, but also a folder storing this file.

FIG. 9 is a flowchart illustrating an example of processing executed in the exemplary embodiment. More specifically, FIG. 9 illustrates an example of file deletion processing. This processing is executed after the list is made in step S402 in FIG. 4.

In step S902, it is judged whether a write authorized user list is empty. If the write authorized user list is empty, the process proceeds to step S908. If the write authorized user list is not empty, the process proceeds to step S904. More specifically, it is judged in step S902 whether the write authorized user field 715 of the object-and-access-right management table 700 of a subject object is empty. “Empty” means that no user other than the user to be deleted is indicated in the write authorized user field 715.

In step S904, the user having exercised write authorization most frequently is added to a candidate list. Such a user can be extracted by using a log management table 1000, for example. FIG. 10 illustrates an example of the data structure of the log management table 1000. The log management table 1000 has a log ID field 1005, an object ID field 1010, an operation date field 1015, an operation user ID field 1020, and an operation field 1025. In the log ID field 1005, information for uniquely identifying a log in the exemplary embodiment, more specifically, a log ID, is stored. In the object ID field 1010, the object ID of an object on which a certain operation is performed is stored. In the operation date field 1015, the date and time on and at which an operation is performed is indicated. In the operation user ID field 1020, the user ID of a user having performed an operation is stored. In the operation field 1025, the type of operation is indicated.

More specifically, users having performed a write operation (indicated in the operation field 1025) on the subject object (represented by the object ID indicated in the object ID field 1010) are extracted. Such users can be extracted by referring to the operation user ID field 1020 of the log management table 1000. For each of the extracted users, the number of write operations is counted, and the user having performed the write operation most frequently is extracted as a candidate for the administrator of the subject object.

In step S906, it is judged whether plural users are included in the candidate list. If plural users are included in the candidate list, the process proceeds to step S908. If plural users are not included in the candidate list, the process proceeds to step S928. In the candidate list, a user having a predetermined relationship with the user to be deleted may be included in advance. For example, the boss of the user to be deleted may be included in the candidate list.

A candidate management table 1100, for example, is generated. FIG. 11 illustrates an example of the data structure of the candidate management table 1100. The candidate management table 1100 has an object ID field 1105, a number-of-candidates field 1110, and a candidate ID field 1115. In the object ID field 1105, the object ID is stored. In the number-of-candidates field 1110, the number of candidates for the administrator of the object represented by the object ID in the object ID field 1105 is indicated. Candidate ID fields 1115 as many as the number of candidates in the number-of-candidates field 1110 are provided in the candidate management table 1100. In the candidate ID field 1115, the user ID of a candidate user is stored.

In step S908, it is judged whether a delete authorized user list is empty. If the delete authorized user list is empty, the process proceeds to step S914. If the delete authorized user list is not empty, the process proceeds to step S910. More specifically, it is judged in step S908 whether the delete authorized user field 720 of the object-and-access-right management table 700 of the subject object is empty. “Empty” means that no user other than the user to be deleted is indicated in the delete authorized user field 720.

In step S910, the user having exercised delete authorization most frequently is added to the candidate list. More specifically, users having performed a delete operation (indicated in the operation field 1025) on the object of another version of the subject object (represented by the object ID in the object ID field 1010) are extracted. Such users can be extracted by referring to the operation user ID field 1020 of the log management table 1000. For each of the extracted users, the number of delete operations is counted, and the user having performed the delete operation most frequently is extracted as a candidate for the administrator of the subject object. “Having exercised delete authorization” means, not that a subject object itself is deleted, but that the object of another version of the subject object (usually, the object of a version prior to the version of the subject object) is deleted.

In step S912, it is judged whether plural users are included in the candidate list. If plural users are included in the candidate list, the process proceeds to step S914. If plural users are not included in the candidate list, the process proceeds to step S928.

In step S914, it is judged whether a read authorized user list is empty. If the read authorized user list is empty, the process proceeds to step S920. If the read authorized user list is not empty, the process proceeds to step S916. More specifically, it is judged in step S914 whether the read authorized user field 725 of the object-and-access-right management table 700 of the subject object is empty. “Empty” means that no user other than the user to be deleted is indicated in the read authorized user field 725.

In step S916, the user having exercised read authorization most frequently is added to the candidate list. More specifically, users having performed a read operation (indicated in the operation field 1025) on the subject object (represented by the object ID indicated in the object ID field 1010) are extracted. Such users can be extracted by referring to the operation user ID field 1020 of the log management table 1000. For each of the extracted users, the number of read operations is counted, and the user having performed the read operation most frequently is extracted as a candidate for the administrator of the subject object.

In step S918, it is judged whether plural users are included in the candidate list. If plural users are included in the candidate list, the process proceeds to step S920. If plural users are not included in the candidate list, the process proceeds to step S928.

In step S920, it is judged whether the candidate list is empty. If the candidate list is empty, the process proceeds to step S922 because there is no candidate for the next administrator of the subject object. If the candidate list is not empty, the process proceeds to step S928.

In step S922, it is judged whether the subject object matches a delete condition. If the subject object matches the delete condition, the process proceeds to step S924. If the subject object does not match the delete condition, the process proceeds to step S926. As discussed above, different delete conditions may be utilized according to whether the user having given an instruction to execute this processing is the user to be deleted (the administrator of the subject object). If the user having given an instruction to execute this processing is the user to be deleted, the delete condition determined by this user is utilized. The user to be deleted determines a condition for deleting an object, based on the past experience. A delete condition management table 1200, for example, may be used. FIG. 12 illustrates an example of the data structure of the delete condition management table 1200. The delete condition management table 1200 has a user ID field 1205, a delete condition field 1210, and a new administrator field 1215. In the user ID field 1205, a user ID is stored. In the delete condition field 1210, a delete condition to be used if the user represented by the user ID is the administrator is indicated. In the new administrator field 1215, a new administrator is indicated. If an object that does not satisfy the delete condition indicated in the delete condition field 1210 is found, the user in the new administrator field 1215 is set to be the new administrator. The delete condition management table 1200 may not have the new administrator field 1215.

If the user having given an instruction to execute this processing is not the user to be deleted, a predetermined rule is utilized. The predetermined rule is a rule determined in accordance with an attribute of an object to be deleted and is equally employed for all objects.

In step S924, the object that matches the delete condition is deleted. Before deleting the object, a query may be made to the user having given an instruction to execute this processing as to whether to delete the object.

In step S926, the operator user (the user having given an instruction to execute this processing) is added to the candidate list.

In step S928, the user selected by the operator user is set to be the administrator user. The administrator user is selected from among the candidates in the candidate list.

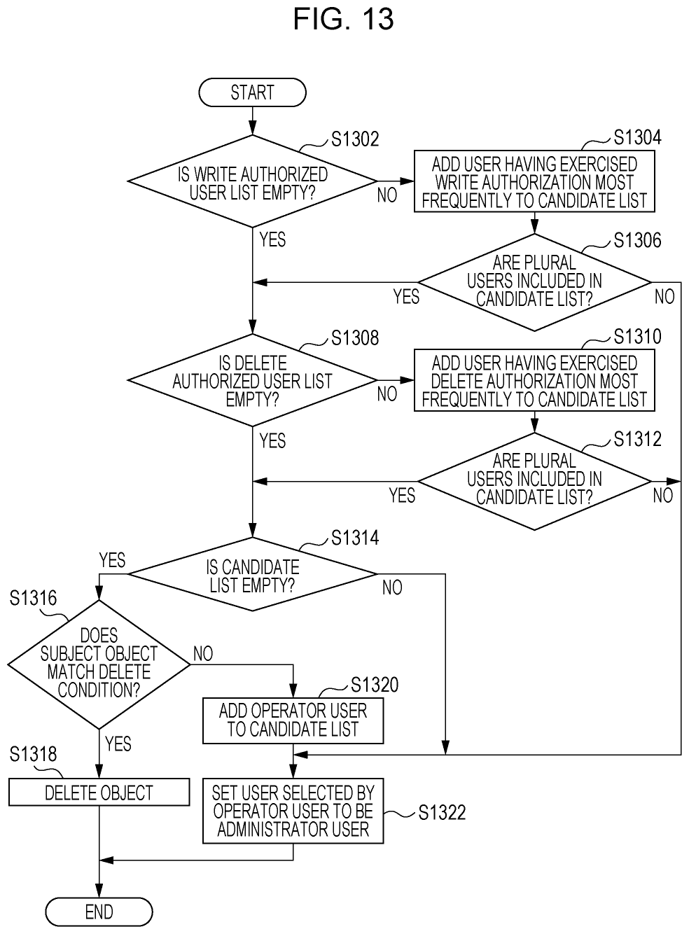

FIG. 13 is a flowchart illustrating an example of processing executed in the exemplary embodiment. More specifically, FIG. 13 is a flowchart illustrating a modified example of processing in the flowchart of FIG. 9. In the flowchart of FIG. 13, steps S914 through S918 in FIG. 9 are removed. That is, a user merely having read a subject object is not selected as the next administrator. The other steps in FIG. 13 are similar to those in FIG. 9.

In step S1302, it is judged whether the write authorized user list is empty. If the write authorized user list is empty, the process proceeds to step S1308. If the write authorized user list is not empty, the process proceeds to step S1304.

In step S1304, the user having exercised write authorization most frequently is added to the candidate list.

In step S1306, it is judged whether plural users are included in the candidate list. If plural users are included in the candidate list, the process proceeds to step S1308. If plural users are not included in the candidate list, the process proceeds to step S1322.

In step S1308, it is judged whether the delete authorized user list is empty. If the delete authorized user list is empty, the process proceeds to step S1314. If the delete authorized user list is not empty, the process proceeds to step S1310.

In step S1310, the user having exercised delete authorization most frequently is added to the candidate list.

In step S1312, it is judged whether plural users are included in the candidate list. If plural users are included in the candidate list, the process proceeds to step S1314. If plural users are not included in the candidate list, the process proceeds to step S1322.

In step S1314, it is judged whether the candidate list is empty. If the candidate list is empty, the process proceeds to step S1316. If the candidate list is not empty, the process proceeds to step S1322.

In step S1316, it is judged whether the subject object matches a delete condition. If the subject object matches the delete condition, the process proceeds to step S1318. If the subject object does not match the delete condition, the process proceeds to step S1320.

In step S1318, the object that matches the delete condition is deleted.

In step S1320, the operator user is added to the candidate list.

In step S1322, the user selected by the operator user is set to be the administrator user.

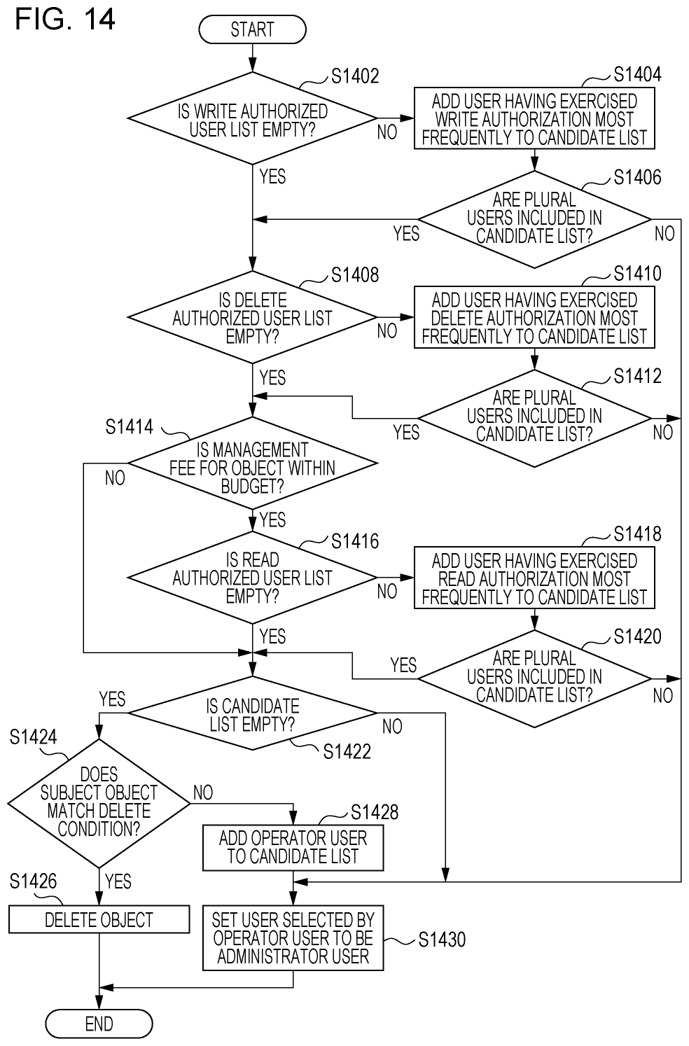

FIG. 14 is a flowchart illustrating an example of processing executed in the exemplary embodiment. More specifically, FIG. 14 is a flowchart illustrating a modified example of processing in the flowchart of FIG. 9. In the flowchart of FIG. 14, step S1414 is added to the flowchart in FIG. 9. The other steps in FIG. 14 are similar to those in FIG. 9.

In step S1402, it is judged whether the write authorized user list is empty. If the write authorized user list is empty, the process proceeds to step S1408. If the write authorized user list is not empty, the process proceeds to step S1404.

In step S1404, the user having exercised write authorization most frequently is added to the candidate list.

In step S1406, it is judged whether plural users are included in the candidate list. If plural users are included in the candidate list, the process proceeds to step S1408. If plural users are not included in the candidate list, the process proceeds to step S1430.

In step S1408, it is judged whether the delete authorized user list is empty. If the delete authorized user list is empty, the process proceeds to step S1414. If the delete authorized user list is not empty, the process proceeds to step S1410.

In step S1410, the user having exercised delete authorization most frequently is added to the candidate list.

In step S1412, it is judged whether plural users are included in the candidate list. If plural users are included in the candidate list, the process proceeds to step S1414. If plural users are not included in the candidate list, the process proceeds to step S1430.

In step S1414, the operator user judges whether the management fee for the subject object is within the budget. If the management fee is within the budget, the process proceeds to step S1416. If the management fee is not within the budget, the process proceeds to step S1422. Step S1414 is an example of processing for instructing the user using the information processing apparatus 100 to determine whether to prioritize the storing of the object or the reducing of a space required for storing the object. That is, if the management fee for the object is not within the budget, it means that the reducing of a space required for storing the object is prioritized. Then, a user merely having read the object is not selected as the next administrator. This increases the possibility that an object that is only read by users will be deleted. If the management fee for the object is within the budget, it means that the storing of the object is prioritized. Then, a user merely having read the object may also be selected as the next administrator. This decreases the possibility that the object will be deleted. In step S1414, the operator user may alternatively judge whether to prioritize the storing of the object or the reducing of a space required for storing the object. If the operator user has selected the reducing of a space required for storing the object, the process proceeds to step S1422. If the operator user has selected the storing of the object, the process proceeds to step S1416.

In step S1416, it is judged whether the read authorized user list is empty. If the read authorized user list is empty, the process proceeds to step S1422. If the read authorized user list is not empty, the process proceeds to step S1418.

In step S1418, the user having exercised read authorization most frequently is added to the candidate list.

In step S1420, it is judged whether plural users are included in the candidate list. If plural users are included in the candidate list, the process proceeds to step S1422. If plural users are not included in the candidate list, the process proceeds to step S1430.

In step S1422, it is judged whether the candidate list is empty. If the candidate list is empty, the process proceeds to step S1424. If the candidate list is not empty, the process proceeds to step S1430.

In step S1424, it is judged whether the subject object matches a delete condition. If the subject object matches the delete condition, the process proceeds to step S1426. If the subject object does not match the delete condition, the process proceeds to step S1428.

In step S1426, the object that matches the delete condition is deleted.

In step S1428, the operator user is added to the candidate list.

In step S1430, the user selected by the operator user is set to be the administrator user.

FIG. 15 is a flowchart illustrating an example of processing executed in the exemplary embodiment. FIG. 15 illustrates an example of folder deletion processing. Steps S1502 through S1520 are similar to steps S902 through S920 in FIG. 9, except that the object is not a file but a folder.

In step S1502, it is judged whether the write authorized user list is empty. If the write authorized user list is empty, the process proceeds to step S1508. If the write authorized user list is not empty, the process proceeds to step S1504.

In step S1504, the user having exercised write authorization most frequently is added to the candidate list.

In step S1506, it is judged whether plural users are included in the candidate list. If plural users are included in the candidate list, the process proceeds to step S1508. If plural users are not included in the candidate list, the process proceeds to step S1522.

In step S1508, it is judged whether the delete authorized user list is empty. If the delete authorized user list is empty, the process proceeds to step S1514. If the delete authorized user list is not empty, the process proceeds to step S1510.

In step S1510, the user having exercised delete authorization most frequently is added to the candidate list.

In step S1512, it is judged whether plural users are included in the candidate list. If plural users are included in the candidate list, the process proceeds to step S1514. If plural users are not included in the candidate list, the process proceeds to step S1522.

In step S1514, it is judged whether the read authorized user list is empty. If the read authorized user list is empty, the process proceeds to step S1520. If the read authorized user list is not empty, the process proceeds to step S1516.

In step S1516, the user having exercised read authorization most frequently is added to the candidate list.

In step S1518, it is judged whether plural users are included in the candidate list. If plural users are included in the candidate list, the process proceeds to step S1520. If plural users are not included in the candidate list, the process proceeds to step S1522.

In step S1520, it is judged whether the candidate list is empty. If the candidate list is empty, the process proceeds to step S1524. If the candidate list is not empty, the process proceeds to step S1522.

In step S1522, the user selected by the operator user is set to be the administrator user. The administrator user is selected from among the candidates in the candidate list.

In step S1524, it is judged whether a file is stored under the subject object (folder). If a file is stored, the process proceeds to step S1526. If no file is stored, the process proceeds to step S1528.

In step S1526, the operator user selects one of the administrators of the files stored under the folder as the administrator of the subject object (folder).

In step S1528, the object (folder) is deleted. Since no file is stored under the folder, the object (folder) is deleted immediately.

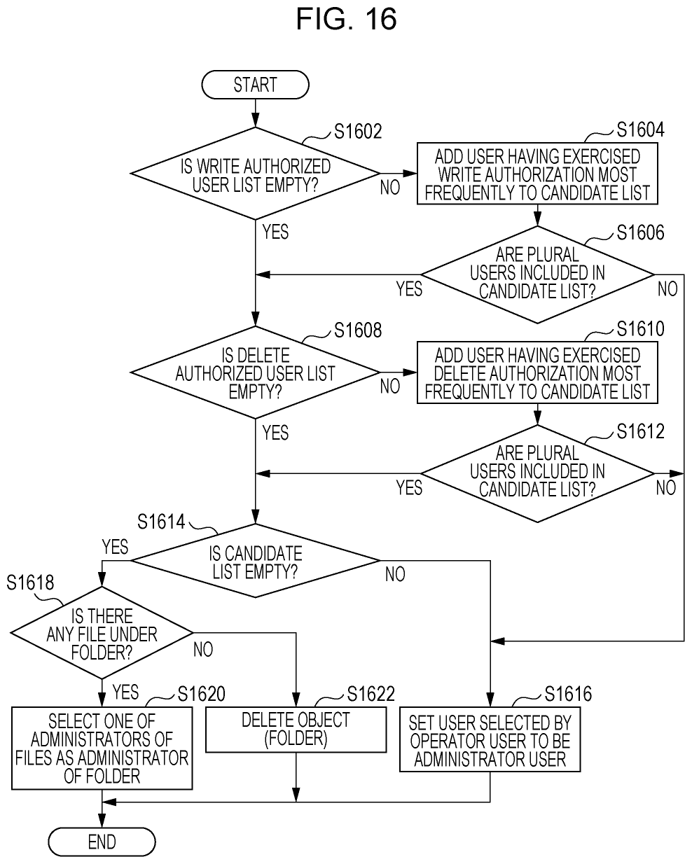

FIG. 16 is a flowchart illustrating an example of processing executed in the exemplary embodiment. More specifically, FIG. 16 is a flowchart illustrating a modified example of processing in the flowchart of FIG. 15. In the flowchart of FIG. 16, steps S1514 through S1518 in FIG. 15 are removed. That is, a user merely having read a subject object is not selected as the next administrator. The other steps in FIG. 16 are similar to those in FIG. 15.

In step S1602, it is judged whether the write authorized user list is empty. If the write authorized user list is empty, the process proceeds to step S1608. If the write authorized user list is not empty, the process proceeds to step S1604.

In step S1604, the user having exercised write authorization most frequently is added to the candidate list.

In step S1606, it is judged whether plural users are included in the candidate list. If plural users are included in the candidate list, the process proceeds to step S1608. If plural users are not included in the candidate list, the process proceeds to step S1616.

In step S1608, it is judged whether the delete authorized user list is empty. If the delete authorized user list is empty, the process proceeds to step S1614. If the delete authorized user list is not empty, the process proceeds to step S1610.

In step S1610, the user having exercised delete authorization most frequently is added to the candidate list.

In step S1612, it is judged whether plural users are included in the candidate list. If plural users are included in the candidate list, the process proceeds to step S1614. If plural users are not included in the candidate list, the process proceeds to step S1616.

In step S1614, it is judged whether the candidate list is empty. If the candidate list is empty, the process proceeds to step S1618. If the candidate list is not empty, the process proceeds to step S1616.

In step S1616, the user selected by the operator user is set to be the administrator user.

In step S1618, it is judged whether a file is stored under the subject object (folder). If a file is stored, the process proceeds to step S1620. If no file is stored, the process proceeds to step S1622.

In step S1620, the operator user selects one of the administrators of the files stored under the folder as the administrator of the subject object (folder).

In step S1622, the object (folder) is deleted.

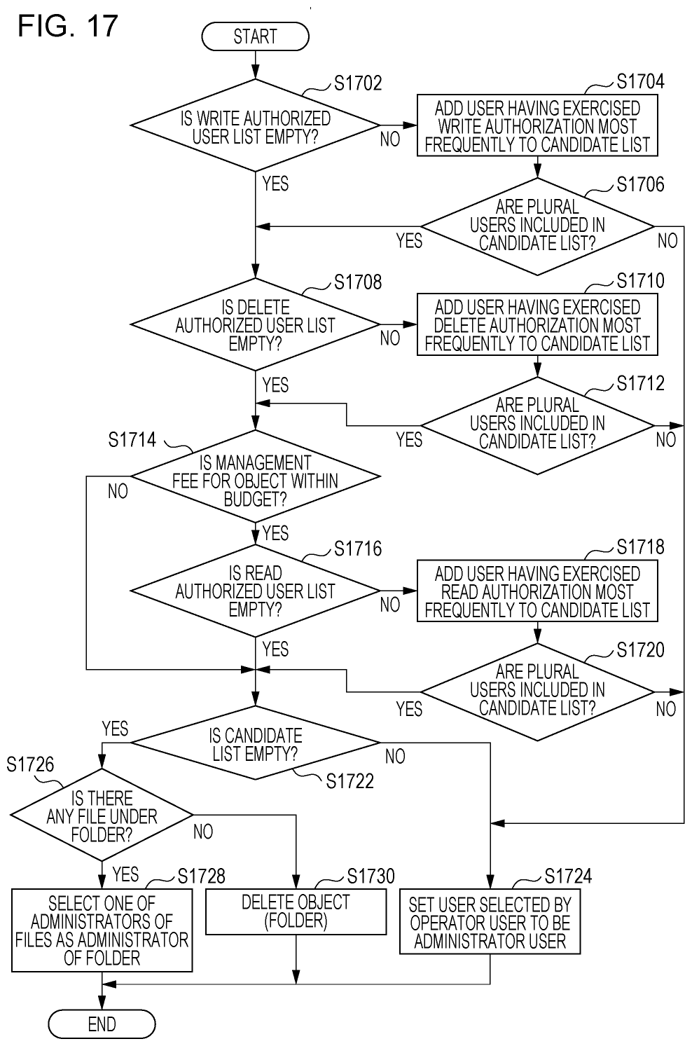

FIG. 17 is a flowchart illustrating an example of processing executed in the exemplary embodiment. More specifically, FIG. 17 is a flowchart illustrating a modified example of processing in the flowchart of FIG. 15. In the flowchart of FIG. 17, step S1714 is added to the flowchart in FIG. 15. The other steps in FIG. 17 are similar to those in FIG. 15.

In step S1702, it is judged whether the write authorized user list is empty. If the write authorized user list is empty, the process proceeds to step S1708. If the write authorized user list is not empty, the process proceeds to step S1704.

In step S1704, the user having exercised write authorization most frequently is added to the candidate list.

In step S1706, it is judged whether plural users are included in the candidate list. If plural users are included in the candidate list, the process proceeds to step S1708. If plural users are not included in the candidate list, the process proceeds to step S1724.

In step S1708, it is judged whether the delete authorized user list is empty. If the delete authorized user list is empty, the process proceeds to step S1714. If the delete authorized user list is not empty, the process proceeds to step S1710.

In step S1710, the user having exercised delete authorization most frequently is added to the candidate list.

In step S1712, it is judged whether plural users are included in the candidate list. If plural users are included in the candidate list, the process proceeds to step S1714. If plural users are not included in the candidate list, the process proceeds to step S1724.

In step S1714, the operator user judges whether the management fee for the subject object is within the budget. If the management fee is within the budget, the process proceeds to step S1716. If the management fee is not within the budget, the process proceeds to step S1722. Step S1714 is similar to step S1414 in FIG. 14.

In step S1716, it is judged whether the read authorized user list is empty. If the read authorized user list is empty, the process proceeds to step S1722. If the read authorized user list is not empty, the process proceeds to step S1718.

In step S1718, the user having exercised read authorization most frequently is added to the candidate list.

In step S1720, it is judged whether plural users are included in the candidate list. If plural users are included in the candidate list, the process proceeds to step S1722. If plural users are not included in the candidate list, the process proceeds to step S1724.

In step S1722, it is judged whether the candidate list is empty. If the candidate list is empty, the process proceeds to step S1726. If the candidate list is not empty, the process proceeds to step S1724.

In step S1724, the user selected by the operator user is set to be the administrator user.

In step S1726, it is judged whether a file is stored under the subject object (folder). If a file is stored, the process proceeds to step S1728. If no file is stored, the process proceeds to step S1730.

In step S1728, the operator user selects one of the administrators of the files stored under the folder as the administrator of the subject object (folder).

In step S1730, the object (folder) is deleted. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. The program may be recorded in any form, for example, it may be compressed or encrypted, as long as it can be reconstructed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory that stores objects and administrators managing the objects in association with each other; and
a processor configured to
select, among the administrators stored in the memory, a second administrator to replace a first administrator managing a first object, as an administrator of the first object, the second administrator being different from the first administrator, and
determine that the first object will be deleted if the processor has failed to select the second administrator.

2. The information processing apparatus according to claim 1, wherein the processor is configured to delete the first object by using one of first and second rules, the first rule being used when a user using the information processing apparatus is the first administrator, the second rule being used when the user using the information processing apparatus is not the first administrator.

3. The information processing apparatus according to claim 2, wherein the first rule is a rule set by the first administrator.

4. The information processing apparatus according to claim 2, wherein the second rule is a rule based on an attribute of the first object.

5. The information processing apparatus according to claim 1, wherein the processor is configured to execute first processing for selecting a user who is authorized to write into the first object and who has written into the first object as the second administrator.

6. The information processing apparatus according to claim 5, wherein the processor is configured to execute second processing for selecting a user who is authorized to delete the first object and who has deleted an object which is another version of the first object as the second administrator if the processor has failed to select the second administrator by executing the first processing.

7. The information processing apparatus according to claim 6, wherein the processor is configured to execute third processing for extracting a user who is authorized to read the first object and who has read the first object as the second administrator if the processor has failed to extract the second administrator by executing the second processing.

8. The information processing apparatus according to claim 7, wherein the processor is configured to:
cause a user using the information processing apparatus to select whether to prioritize storing of the first object or reducing of a space required for storing the first object; and
execute the third processing if the user has selected the storing of the first object.

9. A non-transitory computer readable medium storing a program causing a computer to execute a process, the process comprising:
selecting, from a memory which stores objects and administrators managing the objects in association with each other, among the administrators, a second administrator to replace a first administrator managing a first object, as an administrator of the first object, the second administrator being different from the first administrator; and
determining that the first object will be deleted if selecting of the second administrator has failed.

10. An information processing apparatus comprising:
storing means in which objects and administrators managing the objects are stored in association with each other;
selecting means for selecting, among the administrators stored in the storing means, a second administrator to replace a first administrator managing a first object, as an administrator of the first object, the second administrator being different from the first administrator; and
determining means for determining that the first object will be deleted if the selecting means has failed to select the second administrator.
